(19) United States
(12) Patent Application Publication
(10) Pub. No.: US 2011/0229727 A1
(43) Pub. Date: Sep. 22, 2011

(54) LOW VOC MULTICOLOR COATING

(75) Inventors: John Garuti, JR., New York, NY (US); Louis M. Calvo, Bayshore, NY (US)

(73) Assignee: Formulated Solutions LLC, Woodside, NY (US)

(21) Appl. No.: 12/726,710

(22) Filed: Mar. 18, 2010

(51) Int. Cl. C09D 163/00; C09D 175/04; C09D 131/04; C09D 101/00; C08K 3/08; B32B 21/08; B32B 15/08; B05D 1/02; B05D 1/28; B05D 1/18

(52) U.S. Cl. 428/457; 524/556; 524/563; 524/590; 523/400; 524/35; 524/439; 428/537.1; 427/427.4; 427/429; 427/428.01; 427/430.1

(57) ABSTRACT

A coating composition includes (a) an aqueous polymer emulsion containing a thickener sufficient to provide a viscosity of at least 1,000 at 75 degrees F., and (b) a plurality of particulates suspended in the aqueous polymer emulsion providing special tactile and visual effects such as, for example, multicolor effects, three dimensional effects, metallic sheen and luster, and the like.

### FIELD OF THE INVENTION

The present invention relates to a curable water-based coating composition, and particularly to a coating composition especially for use in multicolor flooring and wall materials and having low VOC content.

### BACKGROUND OF THE ART

Water-based polymer dispersions are finding favor in many markets, not only because they provide performance similar to that obtained from conventional organic solvent-based products, but also because they are leading a worldwide movement toward the use of more environmentally friendly products. For example, water-based polyurethane dispersions offer a variety of advantages, including ease-of-handling, nonflammability, and low toxicity, as well as premium performance. Thus, they are of interest for use in a wide variety of markets and are desirable for use as coatings for coated abrasive articles and antislip products (often referred to as friction surface sheet materials and nonskid sheet materials).

Typically, polyurethane dispersions are alkaline and stabilized such that the polyurethane particles do not agglomerate and/or settle out of the water. This can be done, for example, by neutralizing dispersed polymer acid moieties, such as pendant carboxylic acid moieties, with a basic compound such as ammonia or an amine, e.g., triethylamine. Coatings prepared from many such dispersions generally require the addition of one or more coalescing agents, typically coalescent solvents or “cosolvents,” to allow the formation of a useful film upon drying. Glycol ethers, such as alkyl ethers of ethylene or propylene glycol, have been employed as cosolvents in such applications. However, the use of coalescing organic solvents in water-based systems increases the concentration of undesirable volatile organic compounds (VOCs). A “volatile organic compound” or “VOC,” as used herein, is an organic compound that has a vapor pressure of at least 0.1 mm Hg at 20 degrees C.

Urethane/acrylic copolymers have also been used in water-based curable coating compositions, but not without the use of undesirable amounts of a VOC coalescing agent. Relatively large amounts (e.g., about 20% by weight (wt-%) or greater, based on polymer solids) of coalescing agents have been typically required for effective film formation. Thus, it would be desirable to develop a coating composition for various applications, including for use as a bond material for the manufacture of abrasive articles and antislip products that contain low levels of VOCs.

Multicolor surface coatings have been used successfully for a number of years in both commercial and institutional applications. The original multicolor surface coatings were based on a water and organic solvent incompatibility. This incompatibility keeps the different colors separated, thus creating a multicolor system with one application of the surface coating. However, such coatings typically have high VOC content. With the escalation of environmental concerns, there arose a need to reduce or eliminate the organic solvents in the system. In response to this need, water-born multicolor surface coating compositions were developed.

A major drawback of the prior art water-born multicolor surface coating technology is that special, expensive spray equipment is required to apply the prior art surface coatings. This special equipment is called “High Volume Low Pressure” (HVLP) equipment. It is required because when sprayed at pressures typical for other surface coatings, the prior art multicolored surface coatings lose their multicolor effect due to shearing of the different color particles in the coating into smaller particles, which then fuse together into a single color. It would be of great benefit to be able to use conventional spraying equipment to apply multicolor surface coatings. One approach has been to develop a multicolor surface coating, which could tolerate higher shear forces to allow users of multicolor surface coatings to dispense with a second costly spraying system, as well as reduce the amount of equipment that would need to be transported.

However, it would be preferable to have a low VOC coating, which can be mixed and applied with low shear equipment.

### SUMMARY OF THE INVENTION

A coating composition is provided herein which comprises (a) an aqueous polymer emulsion containing a thickener sufficient to provide a viscosity of at least 1,000 cps at 75 degrees F., and (b) a plurality of particulates suspended in the aqueous polymer emulsion.

### BRIEF DESCRIPTION OF THE DRAWINGS

Various embodiments are described below with reference to the drawings wherein:

FIG. 1 is a sectional view illustrating the cured coating composition applied to a substrate.

### DETAILED DESCRIPTION OF PREFERRED EMBODIMENT(S)

Other than in the working examples or where otherwise indicated, all numbers expressing amounts of materials, reaction conditions, time durations, quantified properties of materials, and so forth, stated in the specification and claims are to be understood as being modified in all instances by the term “about.”

It will also be understood that any numerical range recited herein is intended to include all sub-ranges within that range. It will be further understood that any compound, material or substance which is expressly or implicitly disclosed in the specification and/or recited in a claim as belonging to a group of structurally, compositionally and/or functionally related compounds, materials or substances includes individual representatives of the group and all combinations thereof.

The coating composition herein comprises an aqueous polymer emulsion containing a thickness sufficient to provide a viscosity of at least 1,000 cps at 75 degrees F. to the emulsion. The polymer emulsion is preferably an aqueous acrylic emulsion having from 25 wt % to about 75 wt % acrylic polymer solids in a water based vehicle. Besides acrylics, or in addition to acrylics, the polymer can be selected from urethanes, vinyls, epoxies, and any other homopolymers or copolymers suitable for the use described herein. The VOC content of the coating composition of the invention is less than 50 g/L, preferably less than 10 g/L. In a preferred embodiment there are substantially no VOCs or surfactants in the formulation and no volatile organic solvents.

Suitable aqueous polymer emulsions include, for example, acrylic polymer emulsions, styrene-acrylic polymer emulsions, vinyl acetate-ethylene polymer emulsions, polyurethane emulsions, epoxy polymer emulsions, and combinations thereof. Preferably, the aqueous emulsion, as well as the dried coating formed by it, is clear and colorless. However, if desired, the emulsion can include a color tint or pigment.

An aqueous acrylic emulsion suitable for use in the invention is commercially available from Specialty Polymers, Inc. under the designation RayCryl® 1500, which is a high gloss acrylic latex emulsion polymer and has a solids content of from 43 wt % to 45 wt %, a Brookfield Model RVT viscosity of about 150 cps (#2/100 rpm), a pH of 8.0 to 9.9, a mean particle size of 0.07 microns, a density of 8.7±0.5 lbs/gallon, a minimum film formation temperature (MFFT) of 4 degrees C., and a bulking value of 0.1149 gal/lb.

A thickener is added to the emulsion to increase the viscosity to at least 1,000 cps at 75 degrees F., preferably to at least 5,000 cps 75 degrees F., and more preferably to at least 10,000 cps at 75 degrees F. Preferably, the thickener is a high molecular weight cellulose or cellulose derivative such as, e.g., ethyl cellulose, methyl cellulosecarboxymethyl cellulose (CMC), hydroxyethyl cellulose (HEC) and the like, having a weight average molecular weight of at least from about 100,000 to about 500,000, and preferably from 150,000 to about 350,000. The cellulose or cellulose derivative comprises from about 0.05 wt % to about 5 wt % of the total emulsion weight.

High molecular weight cellulose and cellulose derivatives are commercially available and a preferred cellulose thickener has a molecular weight of about 250,000.

The coating composition includes particulates suspended in the thickened aqueous emulsion. The particulates can include chips and/or flakes of, for example, ground stone, ceramics, glass, plastic, and/or metals such as, for example, stainless steel, aluminum, copper, brass, bronze and the like. Preferably, the particulates are ground marble and/or granite. The particles are preferably of irregular shapes and sizes and preferably range from a fine powder up to about 1 cm in diameter. More preferably at least about 34% by weight of the particles range from about 1.0 mm to about 4.0 mm in diameter. Flakes preferably can range from about 1.0 mm to about 4.0 mm in thickness. The particles are preferably of various shades and/or colors, and are capable of producing special visual and/or tactile effects, such as three dimensional and/or metallic effects (sheen, luster, etc.).

The particulates are then added by mixing into the thickened emulsion by low shear mechanical stirring. By “low shear” mechanical stirring is meant no more than about 120 stirrer revolutions per minute, and preferably from about 80 to 120 revolutions per minute. Low shear mixing is an important feature of the invention as high shear would break up the particulates and cause an undesirable blending of colors. Low shear mixing on the other hand, preserves the differentiation in particle size shape and color, thereby achieving a more pronounced and dramatic visual effect in the final product. A mixer suitable for combining the components of the coating composition of the invention under low sheer conditions is available from Hockmeyer Co. of Elizabeth City, N.C. High shear mixers and applicators are not employed.

Application of the coating composition to the surface of a substrate can be performed by, for example, spraying using an air spray hopper gun, or alternative methods such as brushing, rolling, or dipping.

The coating composition is then applied to a substrate and allowed to cure by drying. The substrate can be of any material suitable for the purposes herein such as ceramic, stone, plastic, wood, metal, and any other material useful in construction. Typically, such a substrate is a tile intended for use as a flooring or wall tile. The coating composition herein can also be applied directly to an interior or exterior wall or floor surface of a permanent fixed structure such as a building, or any other suitable structure.

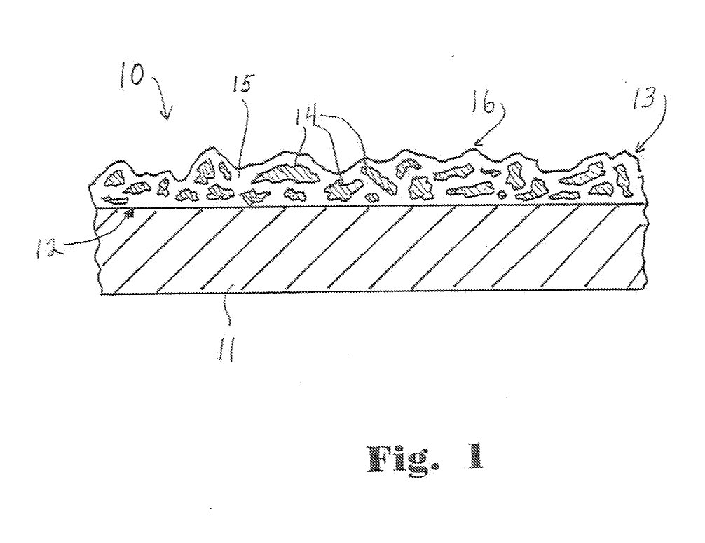

Referring now to FIG. 1, a coated tile 10 includes a substrate 11 having a surface 12 to which the coating composition of the invention 13 has been applied and allowed to dry. The coating 13 includes multicolored particulates 14 embedded in a clear and colorless acrylic matrix 15. As can be seen, the particulates 14 are at various depths within the coating 13 and provide a three dimensional effect which is aesthetically very pleasing. Moreover, the upper surface 16 of the coating is rough and irregular which is not only aesthetically pleasing but also functional as providing floor tiles offering greater protection from accidental slipping, for example, in bathrooms where the floor gets wet.

The present invention is also directed to a method for coating a substrate to have a multicolored three-dimensional appearance. The method can include all or part of the steps since some of the steps may be completed prior to being ready to apply the coating. Adding a thickener to the emulsion that is sufficient to provide a thickened aqueous emulsion having a viscosity of about 1,000 cps to about 10,000 cps at 75 degrees F. Mixing into the thickened aqueous emulsion using low shear consisting a pre-determined amount of particles in order to provide a coating composition. The above steps can be done at site, or can be done off-site and the thickened particles containing aqueous emulsion can be pre-made and stored in an airtight container like a can of paint. Either way, the coating composition can be applied to a prepared surface by brushing, rolling, spraying or dipping onto the surface to produce a coated surface.

The particles used in the coating composition can be in the form of flakes and/or particles which, when applied provide a multicolor textured three-dimensional coating in a single application. One embodiment of the invention includes ground stone or granite that gives the surface an esthetically pleasing appearance of granite at a fraction of the cost.

While the above description contains many specifics, these specifics should not be construed as limitations of the invention, but merely as exemplifications of preferred embodiments thereof. Those skilled in the art will envision many other embodiments within the scope and spirit of the invention as defined by the claims appended hereto.

1. A coating composition comprising:
a) an aqueous polymer emulsion containing a thickener sufficient to provide a viscosity of at least 1,000 cps at 75 degrees F.; and
b) a plurality of particulates suspended in said aqueous polymer emulsion wherein at least about 34 percent by weight of the suspended particulates have a diameter from about 1.0 mm to about 4.0 mm.

2. The coating composition of claim 1 wherein the aqueous polymer emulsion is at least one emulsion selected from the group consisting of acrylic polymer emulsion, styrene-acrylic polymer emulsion, vinyl acetate-ethylene polymer emulsion, polyurethane emulsion, epoxy polymer emulsions and combinations thereof.

3. The coating composition of claim 1 wherein the thickener is a high molecular weight cellulose or cellulose derivative.

4. The coating composition of claim 3 wherein the cellulose or cellulose derivative has a weight average molecular weight of at least 100,000.

5. The coating composition of claim 4 wherein the cellulose or cellulose derivative comprises from about 0.1 wt. % to about 0.5 wt % of the aqueous emulsion.

6. The coating composition of claim 1 wherein said aqueous polymer emulsion is a clear, colorless emulsion.

7. The coating composition of claim 1 wherein the particulates comprise chips and/or flakes of one or more of ground stone, ceramics, glass, plastic, and/or metals.

8. The coating composition of claim 1 wherein the particulates are multicolored and of various shapes and sizes

9. The coating composition of claim 8 wherein the particulates are capable of producing metallic and/or three-dimensional special effects.

10. A substrate coated with the cured coating composition of claim 1.

11. The substrate of claim 9 wherein said substrate is fabricated from ceramic, stone, plastic, wood, or metal.

12. The substrate of claim 11 wherein said substrate is a floor or wall tile.

13. The substrate of claim 11 wherein said substrate is a floor or wall surface of a permanent fixed structure.

14. A method for coating a substrate comprising the steps of:
a) providing an aqueous polymer emulsion;
b) adding a thickener to the aqueous polymer emulsion sufficient to provide a thickened aqueous emulsion having a viscosity of 5,000 cps at 75 degrees F.;
c) mixing into said thickened aqueous emulsion under low shear conditions a quantity of particulates to provide a coating composition; and
d) applying said coating composition to a substrate.

15. The method of claim 14 wherein the aqueous polymer emulsion is at least one emulsion selected from the group consisting of acrylic polymer emulsion, styrene-acrylic polymer emulsion, vinyl acetate-ethylene polymer emulsion, polyurethane emulsion, epoxy polymer emulsions and combinations thereof.

16. The method of claim 14 wherein the thickener is a high molecular weight cellulose or cellulose derivative.

17. The method of claim 16 wherein the cellulose or cellulose derivative has a weight average molecular weight of at least 100,000.

18. The method of claim 16 wherein the cellulose or cellulose derivative comprises from about 0.1 wt. % to about 0.5 wt % of the aqueous emulsion.

19. The method of claim 14 wherein said aqueous emulsion is a clear, colorless emulsion.

20. The method of claim 14 wherein the particulates comprise chips and/or flakes of ground stone, ceramics, glass, plastic, and/or metals.

21. The method of claim 14 wherein the particulates are multicolored and of various shapes and sizes.

22. The method of claim 21 wherein the particulates are capable of producing metallic and/or three-dimensional special effects.

23. The method of claim 14 wherein said substrate is a floor or wall surface of a permanent fixed structure.

24. The method of claim 14 wherein said applying step (d) comprises spraying, brushing, rolling, or dipping.
